(19) United States
(12) Patent Application Publication
(10) Pub. No.: US 2023/0236900 A1
(43) Pub. Date: Jul. 27, 2023

(54) SCHEDULING COMPUTE NODES TO SATISFY A MULTIDIMENSIONAL REQUEST USING VECTORIZED REPRESENTATIONS

(71) Applicant: VMware, Inc., Palo Alto, CA (US)

(72) Inventor: Mustafa Bayramov, Dubai (AE)

(73) Assignee: VMware, Inc., Palo Alto, CA (US)

(21) Appl. No.: 17/580,783

(22) Filed: Jan. 21, 2022

(51) Int. Cl. G06F 9/50

(52) U.S. Cl. CPC G06F 9/5077; G06F 2209/506

(57) ABSTRACT

The present disclosure relates to scheduling compute nodes to satisfy a multidimensional request using vectorized representations. One method includes receiving a request to allocate resources of a distributed virtual environment for a workload, wherein the distributed virtual environment includes a plurality of compute nodes, receiving, for each compute node, node matrix and a utilization vector, determining a mask vector, wherein the mask vector represents constraints associated with the workload, concatenating the plurality of node matrices to form a concatenated matrix, determining a utilization matrix based on the plurality of utilization vectors, and selecting a particular compute node for the workload based on the mask vector, a portion of the concatenated matrix, and the utilization matrix.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may utilize data storage and/or data processing services from the provider in order to run applications that handle the enterprises' core business and operational data. The applications may be proprietary and used exclusively by the enterprise or made available through a network for anyone to access and use.

Virtual computing instances (VCIs), such as virtual machines and containers, have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software-defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

### BRIEF DESCRIPTION OF THE DRAWINGS

FIG. 1 is a diagram of a host and a system for scheduling compute nodes to satisfy a multidimensional request using vectorized representations according to one or more embodiments of the present disclosure.

FIG. 2 is a flow chart associated with scheduling compute nodes to satisfy a multidimensional request using vectorized representations according to one or more embodiments of the present disclosure.

FIG. 3 is a diagram of a system for scheduling compute nodes to satisfy a multidimensional request using vectorized representations according to one or more embodiments of the present disclosure.

FIG. 4 is a diagram of a machine for scheduling compute nodes to satisfy a multidimensional request using vectorized representations according to one or more embodiments of the present disclosure.

FIG. 5 illustrates a method of scheduling compute nodes to satisfy a multidimensional request using vectorized representations according to one or more embodiments of the present disclosure.

### DETAILED DESCRIPTION

The term “virtual computing instance” (VCI) refers generally to an isolated user space instance, which can be executed within a virtualized environment. Other technologies aside from hardware virtualization can provide isolated user space instances, also referred to as data compute nodes (or simply as “compute nodes” and/or “nodes.” Data compute nodes may include non-virtualized physical hosts, VCIs, containers that run on top of a host operating system without a hypervisor or separate operating system, and/or hypervisor kernel network interface modules, among others. Hypervisor kernel network interface modules are non-VCI data compute nodes that include a network stack with a hypervisor kernel network interface and receive/transmit threads.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

Static and dynamic resource schedulers can provide capabilities to select a set of computing resources based on constraints. In many cases, these constraints can be imposed by the requester to the scheduler. A combination of heuristics and a score function can be used to calculate a set of candidate nodes. However, previous approaches to scheduling do not reflect modern requirements for a distributed system, such as multidimensional requests, for instance.

One limitation of previous approaches is the inability to yield a generic representation that scheduling algorithms can consume. Additionally, previous approaches may not provide semantics to impose a set of constraints relevant for modern systems, such as 5G components, cloud-native network function (CNF), and Virtualized Network Functions (VNF). These constraints include a set of graphics processing unit (GPU) resources used for distributed learning algorithms or hardware resources, such as field-programmable gate arrays (FPGAs) and/or hardware accelerators, and other hardware resources used for distributed and 5G systems. These constraints include architectures, such as non-uniform memory access (NUMA), for instance. Previous approaches lack abstract representation and may not be able to accommodate real-time telemetry information. Telemetry information can include latency characteristics of a node, network input/output (TO) utilization, and/or geographic position (e.g., latitude/longitude). Thus, while a heuristic algorithm may calculate scores for a set of compute nodes, the score may not take location and/or latency (among other things) into consideration, rendering such scores inexact.

Embodiments of the present disclosure include extensible, non-specific (e.g., generic), and abstract representations of compute node capabilities. For instance, embodiments herein allow each node in a distributed environment (e.g., system) to communicate vectorized representations of their capabilities to a scheduler. The scheduler can aggregate (e.g., concatenate) these vectorized representations into matrices for use in determining the allocation of resources for a particular workload. Resources can be allocated based on hardware, architecture, utilization, location, etc. As previously discussed, however, embodiments herein are extensible and non-specific, and it will be appreciated that the allocation of resources can be based on factors that are not specifically enumerated herein.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

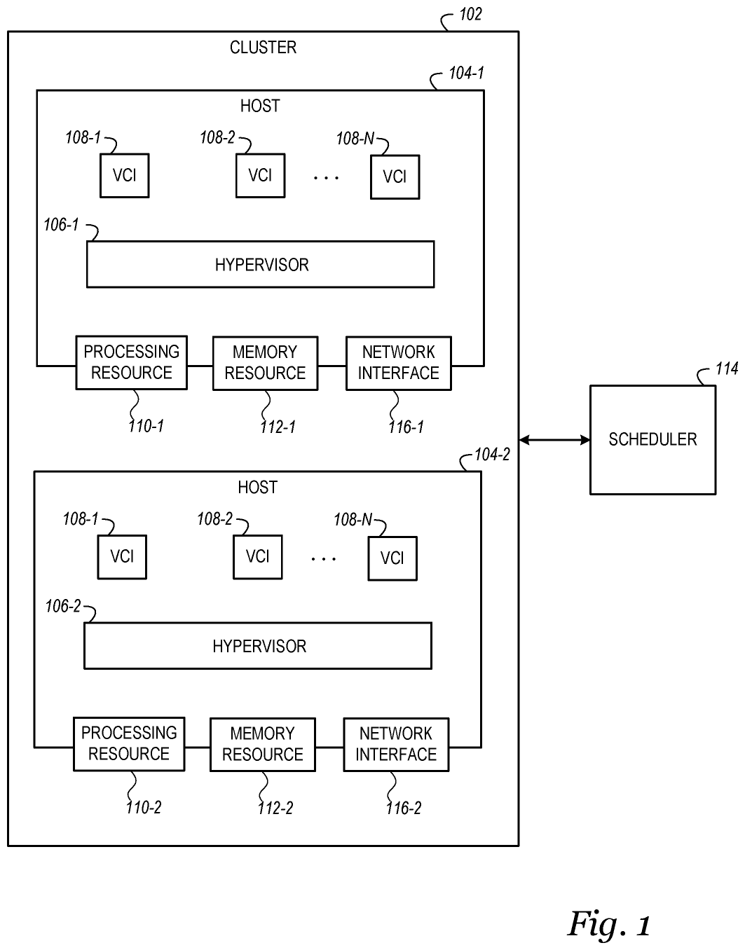

The figures herein follow a numbering convention in which the first digit or digits correspond to the drawing figure number and the remaining digits identify an element or component in the drawing. Analogous elements within a Figure may be referenced with a hyphen and extra numeral or letter. Such analogous elements may be generally referenced without the hyphen and extra numeral or letter. For example, elements 108-1, 108-2, and 108-N in FIG. 1 may be collectively referenced as 108. As used herein, the designator “N”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 is a diagram of a host and a system for scheduling compute nodes to satisfy a multidimensional request using vectorized representations according to one or more embodiments of the present disclosure. The system can include a cluster 102 in communication with a scheduler 114. The cluster 102 can include a first host 104-1 with processing resources 110-1 (e.g., a number of processors), memory resources 112-1, and/or a network interface 116-1. Similarly, the cluster 102 can include a second host 104-2 with processing resources 110-2, memory resources 112-2, and/or a network interface 116-2. Though two hosts are shown in FIG. 1 for purposes of illustration, embodiments of the present disclosure are not limited to a particular number of hosts. For purposes of clarity, the first host 104-1 and/or the second host 104-2 (and/or additional hosts not illustrated in FIG. 1) may be generally referred to as “host 104.” Similarly, reference is made to “hypervisor 106,” “VCI 108,” “processing resources 110,” memory resources 112,” and “network interface 116,” and such usage is not to be taken in a limiting sense.

The host 104 can be included in a software-defined data center. A software-defined data center can extend virtualization concepts such as abstraction, pooling, and automation to data center resources and services to provide information technology as a service (ITaaS). In a software-defined data center, infrastructure, such as networking, processing, and security, can be virtualized and delivered as a service. A software-defined data center can include software-defined networking and/or software-defined storage. In some embodiments, components of a software-defined data center can be provisioned, operated, and/or managed through an application programming interface (API).

The host 104-1 can incorporate a hypervisor 106-1 that can execute a number of VCIs 108-1, 108-2, . . . , 108-N (referred to generally herein as “VCIs 108”). Likewise, the host 104-2 can incorporate a hypervisor 106-2 that can execute a number of VCIs 108. The hypervisor 106-1 and the hypervisor 106-2 are referred to generally herein as a hypervisor 106. The VCIs 108 can be provisioned with processing resources 110 and/or memory resources 112 and can communicate via the network interface 116. The processing resources 110 and the memory resources 112 provisioned to the VCIs 108 can be local and/or remote to the host 104. For example, in a software-defined data center, the VCIs 108 can be provisioned with resources that are generally available to the software-defined data center and not tied to any particular hardware device. By way of example, the memory resources 112 can include volatile and/or non-volatile memory available to the VCIs 108. The VCIs 108 can be moved to different hosts (not specifically illustrated), such that a different hypervisor manages (e.g., executes) the VCIs 108. The host 104 can be in communication with the scheduler 114. In some embodiments, the scheduler 114 can be deployed on a server, such as a web server. The scheduler 114 can include computing resources (e.g., processing resources and/or memory resources in the form of hardware, circuitry, and/or logic, etc.) to perform various operations to schedule resources in the cluster 102.

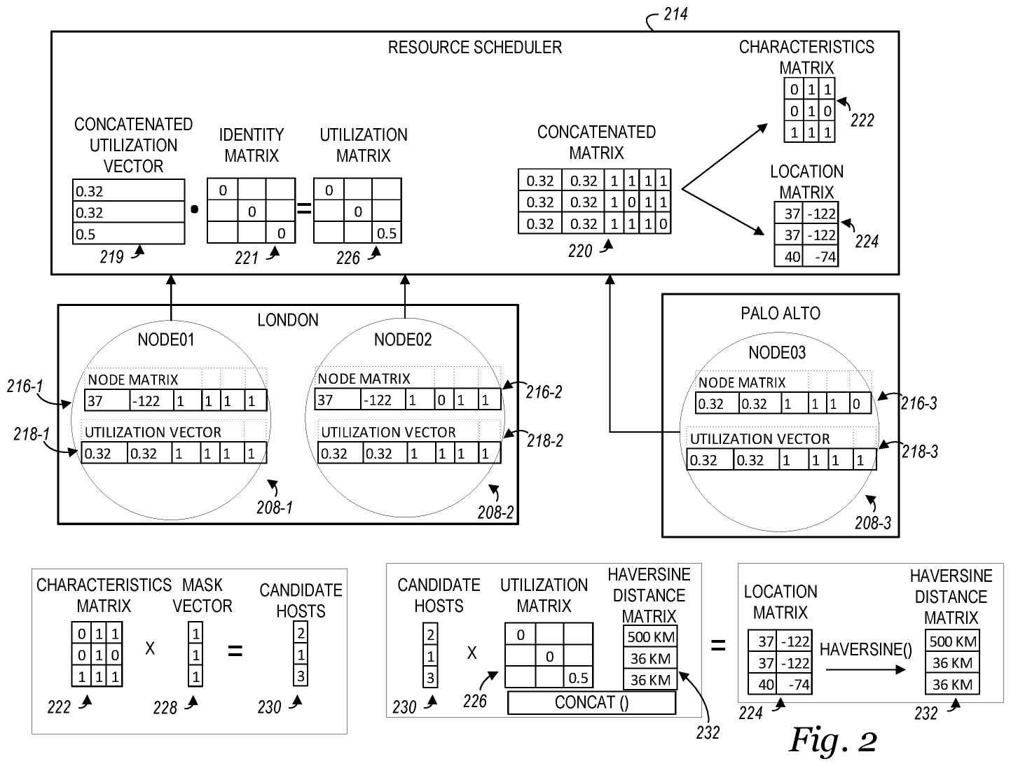

FIG. 2 is a flow chart associated with scheduling compute nodes to satisfy a multidimensional request using vectorized representations according to one or more embodiments of the present disclosure. Each node (node01 208-1, node02 208-2, node03 208-3, referred to cumulatively as “nodes 208”) can communicate (e.g., advertise) a node matrix to a scheduler 214. For instance, node01 208-1 can communicate a node matrix 216-1, node02 208-2 can communicate a node matrix 216-2, node03 208-3 can communicate a node matrix 216-3 (referred to cumulatively as “node matrices 216”). The node matrices 216 can be fixed size D dimension matrices, where a vector column represents hardware resources attached to the respective node. Each column of the node matrix can be one-hot encoded as 0 or 1, and each column position in vector space has a fixed semantical meaning. For example, an example column of a node matrix defines a resource present and available on an example node:

$$c = [ \begin{matrix}{p}_{1} \\ {p}_{2} \\ {x}_{1} \\ {x}_{2} \\ ⋮ \\ {x}_{m}\end{matrix} ]$$

In the above example, p₁=latitude, p₂=longitude, x₁=SRIOV01 (e.g., a virtual channel), x₂=GPU01, x₃=GUP 01, xₙ=FPGA01, where p₁ and p₂ describes the location of the node. Each node matrix 216 can be concatenated to form a concatenated matrix (sometimes referred to herein as “matrix W” 220) m by n size, where m is the quantity of the compute nodes 208 and n is the total size of embedding that the scheduler collects or the nodes 208 advertise. Each compute node 208 can advertise a fixed-size matrix c 216, which, during concatenation, can be transformed to D dimensions and form an n size matrix.

Embodiments herein can split the matrix W 220 by masking the first two rows, yielding a characteristics matrix (sometimes referred to herein as “matrix S”) 222 and a location matrix (sometimes referred to herein as “matrix P”) 224 that stores the latitude and longitude of each of the nodes 216. More generally, embodiments herein can perform masking by shifting the first k row(s) of the matrix W 220, where k is the quantity of metadata (in this example latitude and longitude, k=2).

$$W = [ \begin{matrix}{c}_{1}^{1} , {c}_{2}^{1} , {c}_{3}^{1} \\ {c}_{2}^{2} , {c}_{2}^{2} , {c}_{3}^{2} \\ {c}_{2}^{3} , {c}_{2}^{3} , {c}_{3}^{3} \\ ⋮ \\ {c}_{m}^{n}\end{matrix} ]$$

$$S = [ \begin{matrix}{c}_{1}^{1} , {c}_{2}^{1} , {c}_{3}^{1} \\ {c}_{2}^{2} , {c}_{2}^{2} , {c}_{3}^{2} \\ {c}_{2}^{3} , {c}_{2}^{3} , {c}_{3}^{3} \\ ⋮ \\ {c}_{m}^{n}\end{matrix} ]$$

$$P = [ \begin{matrix}{d}_{1}^{1} , {d}_{2}^{1} \\ {d}_{2}^{2} , {d}_{2}^{2} \\ {d}_{2}^{3} , {d}_{2}^{3} \\ ⋮ \\ {d}_{m}^{n}\end{matrix} ]$$

Each column of these matrices has a logical meaning in a particular context. For example, a 64-dimension matrix can be used to represent 16 SRIOV VF in the system, k quantity of GPUs on compute node(s), and m quantity of FPGAs or accelerators. Accordingly, embodiments herein used fixed-size matrices that can be extended since each column range has a fixed representation of hardware resources.

In some embodiments, the distances between nodes 208 and a location associated with the request may be relevant. In such embodiments, a haversine distance matrix (sometimes referred to as “matrix D”) 232 can be determined. The output of matrix D 232 describes the distance to each compute node. The matrix D 232 is a same size as the quantity of nodes 208:

$$D = 2 r arcsin ( \sqrt{hav ( {φ}_{2} - {φ}_{1} ) + cos ( {φ}_{1} ) cos ( {φ}_{2} ) hav ( {λ}_{2} - {λ}_{1} )} )$$

$$= 2 r arcsin ( \sqrt{{sin}^{2} ( \frac{{φ}_{2} - {φ}_{1}}{2} ) + cos ( {φ}_{1} ) cos ( {φ}_{2} ) {sin}^{2} ( \frac{{λ}_{2} - {λ}_{1}}{2} )} )$$

As discussed further below, the selection of a particular one of the nodes 208 can include the following determination for the matrix D 232:

D=hav(P,LOC)

It is to be appreciated that matrix D 232 is

d=[d_{i,j}]ϵ [symbol] ²

where each row corresponds to a distance metric, such as, for example:

$$[ [ \begin{matrix}37.441883 & - 122.143021\end{matrix} ]$$

$$[ \begin{matrix}37.441883 & - 122.143021\end{matrix} ]$$

$$[ \begin{matrix}37.441883 & - 122.143021\end{matrix} ]$$

$$[ \begin{matrix}37.441883 & - 122.143021\end{matrix} ]$$

$$[ \begin{matrix}40.712776 & - 74.005974\end{matrix} ]$$

$$[ \begin{matrix}40.712776 & - 74.005974\end{matrix} ]$$

$$[ \begin{matrix}37.441883 & - 122.143021\end{matrix} ]$$

$$[ \begin{matrix}37.441883 & - 122.143021\end{matrix} ] ]$$

$$[ [ 36.54802004 ]$$

$$[ 36.54802004 ]$$

$$[ 36.54802004 ]$$

$$[ 36.54802004 ]$$

$$[ 5381.68289562 ]$$

$$[ 5381.68289562 ]$$

$$[ 36.54802004 ]$$

$$[ 36.54802004 ] ] .$$

Embodiments herein can determine a utilization vector 218 (sometimes referred to as “vector u” 218) for each of the nodes 208. For instance, a first utilization vector 218-1 can be determined for node01 208-1, a second utilization vector 218-2 can be determined for node02 208-2, and a third utilization vector 218-3 can be determined for node03 208-3. Each component in vector u 218 is an output of a score function for each of the nodes 208. The score function determines a score on a scale between 0 and 1.

$$score ( x ) = {\sum }_{d = 1}^{D} - {x}_{d} log {\hat{x}}_{d} - ( 1 - {x}_{d} ) log ( 1 - {\hat{x}}_{d} )$$

The utilization vectors 218 can be concatenated into a concatenated utilization vector 219. Each component of the concatenated utilization vector 219 is an output of a cost function for each of the plurality of nodes 208. The concatenated utilization vector 219 can be:

$$u = [ \begin{matrix}{u}_{1} = score ( {u}_{1} ) \\ {u}_{2} = score ( {u}_{2} ) \\ {u}_{3} = score ( {u}_{3} ) \\ ⋮ \\ {u}_{n} = score ( {u}_{u} )\end{matrix} ]$$

The concatenated utilization vector 219 can be transformed to a diagonal matrix U with a size of m by m by transforming via pairwise multiplication with an identity matrix (I) 221 that forms a utilization matrix (U) 226:

$$U = [ \begin{matrix}1 & & \\ & ⋱ & \\ & & {1}_{m}\end{matrix} ] \cdot [ \begin{matrix}{u}_{1} \\ {u}_{2} \\ {u}_{3} \\ ⋮ \\ {u}_{u}\end{matrix} ] = [ \begin{matrix}{score}_{{u}_{1}} & & \\ & ⋱ & \\ & & {score}_{{u}_{n}}\end{matrix} ]$$

Embodiments herein can determine a mask vector (m) 228 that represents constraints associated with the workload. Stated differently, the mask vector 228 can be a 1D vector that describes a vector-valued mask, whose entries represent a set of constraints. Each column position can indicate what component is to be presented and determined in the ultimate output matrix.

For example, if the scheduler 214 is to consider only a subset of the nodes 208 that provide GPU accelerators (in accordance with a specification of the request), it can construct a one-hot encoded mask with entities that correspond to the GPU columns. Then, the scheduler 214 can determine the mask vector 228. The mask component of the mask vector 228 can be set to 0 for an element that is not relevant to the request (e.g., if the request does not specify an element). Each column index has local semantics but the order of the columns aggregated from the nodes 208 holds the same semantical meaning. Thus, if the mask vector 228 is to match GPU and FPGA, for instance, the column position is fixed in advance for all node matrices 216. Embodiments herein use fixed-size vector representation. The mask vector 228 can be represented as:

m=[m₁,m₂,m₃]

Where m, the output of a first matrix-vector operation and vector r is n dimensions (e.g., n being the quantity of nodes 208). After the first matrix multiplication, the scheduler 214 determines vector r, and the second matrix multiplication with the utilization matrix (U) 226 outputs a pairwise final score.

In some embodiments, the final output is an n-dimensional Z vector, wherein each row corresponds to one of the nodes 208. The scheduler 214 can obtain a node identifier (node ID) from the row number. The argmax function outputs a row number that corresponds to a maximum score. In embodiments where location is not factored in, the determination can be:

r=S·m

Z=argmax[r·U]

In embodiments where location is factored in, the scheduler 214 can first determine the masked output:

r=S·m

and determine a utilization score. A SELECT operator can be denoted such that: Let A=[a_{i,j}]ϵ [symbol] ²

$$SELECT := \{ {a}_{i , j} \vert 1 \leq i \leq N , 1 \leq j \leq M and {a}_{i , j} \geq max \}$$

$$r = S \cdot m$$

$$r = r \cdot U$$

$$Z = CONCAT [ {r}^{T} , D ]$$

$$M = {max}_{1 \leq i \leq m} {r}_{ik}$$

$$R = SELECT ( M )$$

Where

S=[s₁, . . . ,sₛ]ϵ [symbol] ^{N×M},

In some embodiments, the last step outputs candidate hosts (e.g., all candidate hosts) 230, and the scheduler can select from these candidates 230 based on proximity.

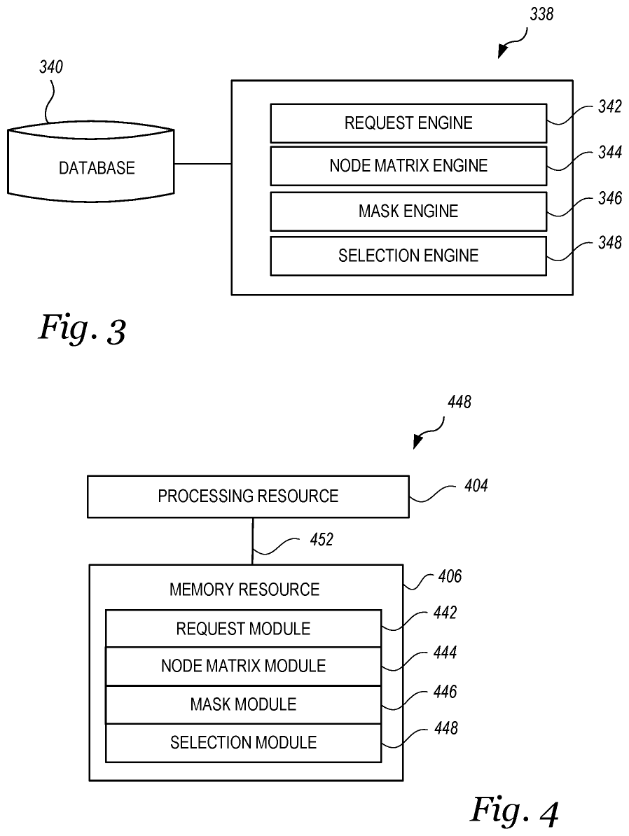

FIG. 3 is a diagram of a system 338 for scheduling compute nodes to satisfy a multidimensional request using vectorized representations according to one or more embodiments of the present disclosure. The system 338 can include a database 340 and/or a number of engines, for example request engine 342, node matrix engine 344, mask engine 346, and/or selection engine 348, and can be in communication with the database 340 via a communication link. The system 338 can include additional or fewer engines than illustrated to perform the various functions described herein. The system can represent program instructions and/or hardware of a machine (e.g., machine 448 as referenced in FIG. 4, etc.). As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, a field programmable gate array, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware. In some embodiments, the request engine 342 can include a combination of hardware and program instructions that is configured to receive a request to allocate resources of a distributed virtual environment for a workload. As previously discussed, the distributed virtual environment can include a plurality of compute nodes.

In some embodiments, the node matrix engine 344 can include a combination of hardware and program instructions that is configured to receive a node matrix and a utilization vector for (e.g., from) each compute node. A node matrix the node matrix can represent characteristics and location information of the compute node, and the utilization vector can represent metrics associated with the compute node. In some embodiments, the mask engine 346 can include a combination of hardware and program instructions that is configured to determine a mask vector that represents constraints associated with the workload.

In some embodiments, the selection engine 348 can include a combination of hardware and program instructions that is configured to concatenate the plurality of node matrices to form a concatenated matrix, split the concatenated matrix into a characteristics matrix and a location matrix, determine a utilization matrix based on the plurality of utilization vectors, and select a particular compute node for the workload based on the mask vector, the characteristics matrix, and the utilization matrix. In some embodiments, the selection engine 348 is configured to concatenate the plurality of utilization vectors into a concatenated utilization vector. Each component of such a concatenated utilization vector can be an output of a cost function for each of the plurality of compute nodes. In some embodiments, the selection engine 348 is configured to determine the utilization matrix by transforming the concatenated utilization matrix via pairwise multiplication with an identity matrix.

FIG. 4 is a diagram of a machine for scheduling compute nodes to satisfy a multidimensional request using vectorized representations according to one or more embodiments of the present disclosure. The machine 448 can utilize software, hardware, firmware, and/or logic to perform a number of functions. The machine 448 can be a combination of hardware and program instructions configured to perform a number of functions (e.g., actions). The hardware, for example, can include a number of processing resources 404 and a number of memory resources 406, such as a machine-readable medium (MRM) or other memory resources 406. The memory resources 406 can be internal and/or external to the machine 448 (e.g., the machine 448 can include internal memory resources and have access to external memory resources). In some embodiments, the machine 448 can be a virtual computing instance (VCI). The program instructions (e.g., machine-readable instructions (MRI)) can include instructions stored on the MRM to implement a particular function (e.g., an action such as determining one or more matrices, as described herein). The set of MRI can be executable by one or more of the processing resources 404. The memory resources 406 can be coupled to the machine 448 in a wired and/or wireless manner. For example, the memory resources 406 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resources 406 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media.

The processing resources 404 can be coupled to the memory resources 406 via a communication path 452. The communication path 452 can be local or remote to the machine 448. Examples of a local communication path 452 can include an electronic bus internal to a machine, where the memory resources 406 are in communication with the processing resources 408 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 452 can be such that the memory resources 406 are remote from the processing resources 404, such as in a network connection between the memory resources 406 and the processing resources 404. That is, the communication path 452 can be a network connection. Examples of such a network connection can include a local area network (LAN), wide area network (WAN), personal area network (PAN), and the Internet, among others.

As shown in FIG. 4, the MM stored in the memory resources 406 can be segmented into a number of modules 442, 444, 446, 448 that when executed by the processing resources 404 can perform a number of functions. As used herein a module includes a set of instructions included to perform a particular task or action. The number of modules 442, 444, 446, 448 can be sub-modules of other modules. For example, the node matrix module 444 can be a sub-module of the request module 442 and/or can be contained within a single module. Furthermore, the number of modules 442, 444, 446, 448 can comprise individual modules separate and distinct from one another. Examples are not limited to the specific modules 442, 444, 446, 448 illustrated in FIG. 4.

Each of the number of modules 442, 444, 446, 448 can include program instructions and/or a combination of hardware and program instructions that, when executed by a processing resource 404, can function as a corresponding engine as described with respect to FIG. 3. For example, the request module 442 can include program instructions and/or a combination of hardware and program instructions that, when executed by a processing resource 404, can function as the mapping engine 342, though embodiments of the present disclosure are not so limited. The machine 448 can include a request module 442, which can include instructions to receive a request to allocate resources of a distributed virtual environment for a workload, wherein the distributed virtual environment includes a plurality of compute nodes.

The machine 448 can include a node matrix module 444, which can include instructions to receive, for each compute node, a node matrix and a utilization vector for each compute node. The node matrices can represent characteristics and location information of the respective compute nodes. The utilization vectors can represent metrics associated with the respective compute nodes. The machine 448 can include a mask module 446, which can include instructions to determine a mask vector, wherein the mask vector represents constraints associated with the workload. The machine 448 can include a selection module 448, which can include instructions to concatenate the plurality of node matrices to form a concatenated matrix, split the concatenated matrix into a characteristics matrix and a location matrix, determine a utilization matrix based on the plurality of utilization vectors, and select a particular compute node for the workload based on the mask vector, the characteristics matrix, and the utilization matrix.

In some embodiments, the machine 448 includes instructions to determine a haversine distance matrix representing distances between the location associated with the workload and each of the plurality of compute nodes. In some embodiments, the machine 448 includes instructions to select the particular compute node for the workload based on the mask vector, the characteristics matrix, the utilization matrix, and the haversine distance matrix.

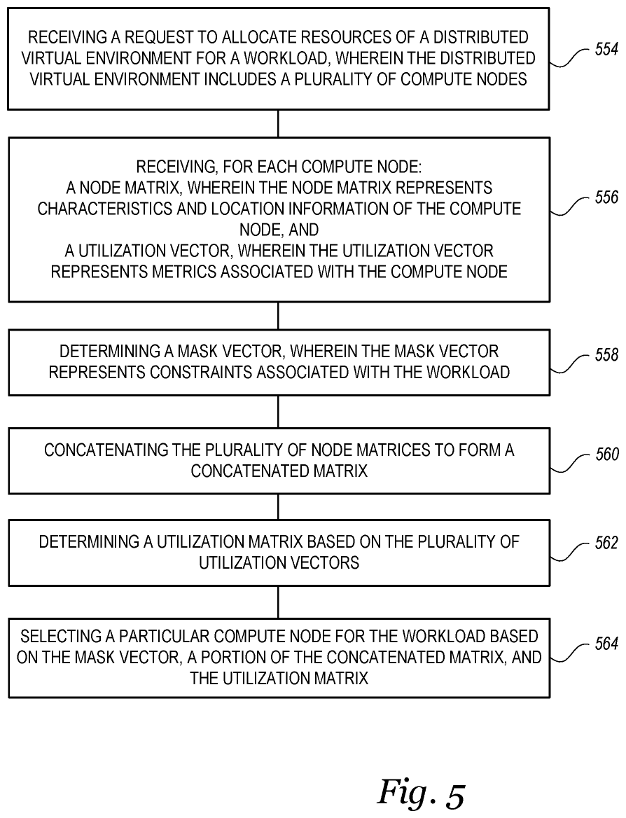

FIG. 5 illustrates a method of scheduling compute nodes to satisfy a multidimensional request using vectorized representations according to one or more embodiments of the present disclosure. At 554, the method includes receiving a request to allocate resources of a distributed virtual environment for a workload, wherein the distributed virtual environment includes a plurality of compute nodes. At 556, the method includes receiving, for each compute node, a node matrix, wherein the node matrix represents characteristics and location information of the compute node, and a utilization vector, wherein the utilization vector represents metrics associated with the compute node.

At 558, the method includes determining a mask vector, wherein the mask vector represents constraints associated with the workload. At 560, the method includes concatenating the plurality of node matrices to form a concatenated matrix. The concatenated matrix can be a size of m by n, where m is the quantity of the compute nodes and n is the total size of embedding that the scheduler collects or the nodes advertise.

At 562, the method includes determining a utilization matrix based on the plurality of utilization vectors. Determining the utilization matrix can include concatenating the plurality of utilization vectors into a concatenated utilization vector, wherein each component of the concatenated utilization vector is an output of a cost function for each of the plurality of compute nodes. Determining the utilization matrix can include transforming the concatenated utilization matrix via pairwise multiplication with an identity matrix.

At 564, the method includes selecting a particular compute node for the workload based on the mask vector, a portion of the concatenated matrix, and the utilization matrix. Determining the portion of the concatenated matrix can include splitting the concatenated matrix into a characteristics matrix and a location matrix. In some embodiments, selecting the particular compute node for the workload is based on the mask vector, the characteristics matrix, and the utilization matrix. In some embodiments, selecting the particular compute node for the workload is based on the mask vector, the characteristics matrix, the location matrix, and the utilization matrix. In some embodiments, selecting the particular compute node for the workload includes selecting from an output matrix having a plurality of rows using an argmax function, wherein each row of the output matrix corresponds to one of the plurality of compute nodes.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving a request to allocate resources of a distributed virtual environment for a workload, wherein the distributed virtual environment includes a plurality of compute nodes;
receiving, for each compute node:
a node matrix, wherein the node matrix represents characteristics and location information of the compute node; and
a utilization vector, wherein the utilization vector represents metrics associated with the compute node;
determining a mask vector, wherein the mask vector represents constraints associated with the workload;
concatenating the plurality of node matrices to form a concatenated matrix;
determining a utilization matrix based on the plurality of utilization vectors; and
selecting a particular compute node for the workload based on the mask vector, a portion of the concatenated matrix, and the utilization matrix.

2. The method of claim 1, wherein determining the portion of the concatenated matrix includes splitting the concatenated matrix into a characteristics matrix and a location matrix, and wherein the method includes selecting the particular compute node for the workload based on the mask vector, the characteristics matrix, and the utilization matrix.

3. The method of claim 2, wherein the method includes selecting the particular compute node for the workload based on the mask vector, the characteristics matrix, the location matrix, and the utilization matrix.

4. The method of claim 1, wherein determining the utilization matrix includes concatenating the plurality of utilization vectors into a concatenated utilization vector, wherein each component of the concatenated utilization vector is an output of a cost function for each of the plurality of compute nodes.

5. The method of claim 4, wherein determining the utilization matrix includes transforming the concatenated utilization matrix via pairwise multiplication with an identity matrix.

6. The method of claim 1, wherein selecting the particular compute node for the workload includes selecting from an output matrix having a plurality of rows using an argmax function, wherein each row of the output matrix corresponds to one of the plurality of compute nodes.

7. A non-transitory machine-readable medium having instructions stored thereon which, when executed by a processor, cause the processor to:
receive a request to allocate resources of a distributed virtual environment for a workload, wherein the distributed virtual environment includes a plurality of compute nodes;
receive, for each compute node:
a node matrix, wherein the node matrix represents characteristics and location information of the compute node; and
a utilization vector, wherein the utilization vector represents metrics associated with the compute node;
determine a mask vector, wherein the mask vector represents constraints associated with the workload;
concatenate the plurality of node matrices to form a concatenated matrix;
split the concatenated matrix into a characteristics matrix and a location matrix;
determine a utilization matrix based on the plurality of utilization vectors; and
select a particular compute node for the workload based on the mask vector, the characteristics matrix, and the utilization matrix.

8. The medium of claim 7, wherein the request specifies a location associated with the workload.

9. The medium of claim 8, wherein the location matrix includes a first column corresponding to latitude and a second column corresponding to longitude.

10. The medium of claim 9, including instructions to determine a haversine distance matrix representing distances between the location associated with the workload and each of the plurality of compute nodes.

11. The medium of claim 10, including instructions to select the particular compute node for the workload based on the mask vector, the characteristics matrix, the utilization matrix, and the haversine distance matrix.

12. The medium of claim 7, wherein characteristics of the compute node include:
hardware devices attached to the compute node;
capabilities of the compute node; and
architecture associated with the compute node.

13. The medium of claim 7, wherein the characteristics matrix is one-hot encoded.

14. The medium of claim 7, wherein the node matrix for each of the plurality of compute nodes is a same size.

15. A system, comprising:
a request engine configured to receive a request to allocate resources of a distributed virtual environment for a workload, wherein the distributed virtual environment includes a plurality of compute nodes;
a node matrix engine configured to receive, for each compute node:
a node matrix, wherein the node matrix represents characteristics and location information of the compute node; and
a utilization vector, wherein the utilization vector represents metrics associated with the compute node;
a mask engine configured to determine a mask vector, wherein the mask vector represents constraints associated with the workload;
a selection engine configured to:
concatenate the plurality of node matrices to form a concatenated matrix;
split the concatenated matrix into a characteristics matrix and a location matrix;
determine a utilization matrix based on the plurality of utilization vectors; and
select a particular compute node for the workload based on the mask vector, the characteristics matrix, and the utilization matrix.

16. The system of claim 15, wherein the selection engine is configured to concatenate the plurality of utilization vectors into a concatenated utilization vector, wherein each component of the concatenated utilization vector is an output of a cost function for each of the plurality of compute nodes.

17. The system of claim 16, wherein the selection engine is configured to determine the utilization matrix by transforming the concatenated utilization matrix via pairwise multiplication with an identity matrix.

18. The system of claim 15, wherein the constraints associated with the workload include a particular hardware device specified for the workload.

19. The system of claim 15, wherein the constraints associated with the workload include a threshold distance between a location associated with the workload and the particular compute node.

20. The system of claim 15, wherein the constraints associated with the workload include:
a field-programmable gate array (FPGA); and
a hardware accelerator.
